(19) United States
(12) Patent Application Publication
(10) Pub. No.: US 2020/0325300 A1
(43) Pub. Date: Oct. 15, 2020

(54) FABRICATION OF POLYMER NANOCOMPOSITES FOR USE AS FIBER LASER CLADDINGS

(71) Applicant: The Government of the United States of America, as represented by the Secretary of the Navy, Arlington, VA (US)

(72) Inventors: Darryl A. Boyd, Alexandria, VA (US); Daniel Rhonehouse, Chesapeake Beach, MD (US); Colin C. Baker, Alexandria, VA (US); L. Brandon Shaw, Woodbridge, VA (US); Woohong Kim, Lorton, VA (US); Jasbinder S. Sanghera, Ashburn, VA (US)

(21) Appl. No.: 16/844,138

(22) Filed: Apr. 9, 2020

Related U.S. Application Data
(60) Provisional application No. 62/833,057, filed on Apr. 12, 2019.

(51) Int. Cl. C08K 3/16; G02B 1/04; C08J 3/20; C09D 7/61

(52) U.S. Cl. CPC C08K 3/16; G02B 1/048; C08J 2300/102; C09D 7/61; C08K 2003/166; C08J 3/203

(57) ABSTRACT

This application relates generally to polymer materials comprising nanoscale ceramic particles for use as a coating in clad pump fiber lasers, including those that function at eye-safer wavelengths and the related method of making them. Fluorinated polymers that possess low refractive index, low optical loss, and high thermal stability are combined with fluorinated ceramic nanoparticles that possess low refractive index and high thermal conductivity to develop a polymer material.

### CROSS-REFERENCE TO RELATED APPLICATIONS

This application is a non-provisional application of U.S. Provisional Application No. 62/833,057, filed on Apr. 12, 2019, the contents of which is incorporated herein by reference in its entirety.

### TECHNICAL FIELD

This application relates generally to polymer materials comprising nanoscale ceramic particles for use as a coating in clad pump fiber lasers, including those that function at eye-safer wavelengths and the related method of making them.

### BACKGROUND OF THE INVENTION

Double clad fiber lasers often use a polymer outer cladding, or pump cladding layer for pump light confinement. Therefore, for this polymer cladding to be effective it must have a lower refractive index than the inner cladding layer (often pure silica) to confine the pump light. This polymer cladding must also have a low absorption at the pump wavelengths, where the evanescent field from the pump light is absorbed into the polymer layer as it travels along the length of the fiber. The absorption that inevitably occurs during pumping will cause heating of the polymer, and therefore the polymer must have a high thermal conductivity. And finally, given this heat generation in the fiber, the polymer must be thermally stable. Current polymers that serve as the pump cladding have low absorptions at wavelengths associated with Yb³⁺ doped silica fibers, where pump light in the 975 nm region is used. However, these polymers have large absorptions at longer wavelengths, where absorptions begin to significantly increase beyond ˜1.4 μm. This region lies in the “eye safer” wavelength region where the next generation of fiber lasers are being developed for modern technologies including LIDAR, medical, material processing, and other applications. These laser systems include Er³⁺ and Ho³⁺ doped silica fibers which benefit greatly by resonant or “in band pumping” at wavelengths in the ˜1.5-2 μm region for higher efficiency operation. Therefore the major requirements for such an optical polymer coating in clad pump fiber lasers are that the coating must possess low refractive index, maintain low absorption at the laser pump wavelengths, and have high thermal stability and conductivity. The present invention employs a method of increasing the thermal conductivity of fluorinated polymer resins while maintaining low refractive index, low absorption, and high thermal stability, by the incorporation of ceramic nanoparticles, to make the overall polymer composites viable as polymer claddings for fiber lasers, especially at eye-safer wavelengths (e.g. >1.4 μm), thus broadening the scope of applications in which laser technology can be used. The nanoparticle doped polymers can also provide superior thermal performance at non-eye safer wavelengths compared to the traditional polymers currently being used.

### SUMMARY OF THE INVENTION

The invention described herein, including the various aspects and/or embodiments thereof, meets the unmet needs of the art, as well as others, by providing polymer materials comprising nanoscale ceramic particles that impart enhanced thermal conductivity to the overall polymer composite, for use as a polymer coating in clad pump fiber lasers, including those that function at eye-safer wavelengths. Several advantages of the present invention include:
The creation of a material with increased thermal conductivity as the loading volume percentage of nanoparticle increases.
The creation of a material that maintains refractive index as loading volume percentage of nanoparticle increases. (The refractive index is maintained within a range that does not preclude it from use as a polymer cladding for fiber laser—there may be a minimal increase or decrease in refractive index.)
The creation of a material that has low optical loss as loading volume percentage of nanoparticle increases.
The creation of a material that has high thermal stability as loading volume percentage of nanoparticle increases.

Other features and advantages of the present invention will become apparent to those skilled in the art upon examination of the following or upon learning by practice of the invention.

### BRIEF DESCRIPTION OF THE DRAWINGS

FIG. 1 shows a schematic for the fabrication of fluorinated polymer composites (FPC).

FIG. 2A shows a thermally curable FPC solution prior to curing. FIG. 2B shows a thermally curable FPC as a bulk polymer. FIG. 2C shows a thermally curable FPC as a thin film.

FIG. 3 is a cross-section image of a silica fiber coated with a FPC made using a UV curable resin.

FIGS. 4A and 4B show refractive index values at various wavelengths. FIG. 4A is for thermally cured polymers, and FIG. 4B is for UV cured polymers. In both FIGS. 4A and 4B, solid plots represent FPCs and dashed plots represent the neat polymers.

FIG. 5A is a transmission plot for 200 μm thick thermally cured FPC. FIG. 5B is a transmission plot for 6 mm thick UV cured FPC.

FIG. 6A is a degradation profile as temperature increases for a neat thermally curable polymer. FIG. 6B is a degradation profile as temperature increases for a thermally curable FPC. The temperature at which 0.95 weight fraction remains is indicated on each plot.

FIG. 7A is a degradation profile as temperature increases for a neat UV curable polymer. FIG. 7B is a degradation profile as temperature increases for a UV curable FPC. The temperature at which 0.95 weight fraction remains is indicated on each plot.

FIG. 8 is a plot of thermal conductivity vs. % LiF nanoparticle concentration for the UV curable FPC polymer.

### DETAILED DESCRIPTION OF EMBODIMENTS OF THE INVENTION

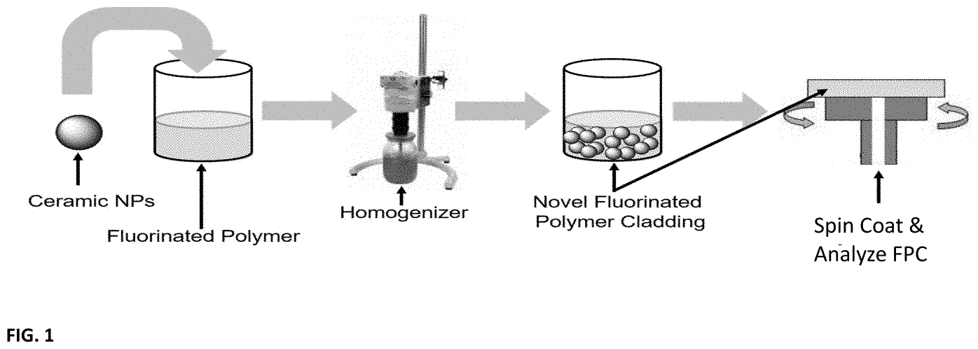

The present invention combines fluorinated polymers that possess low refractive index, low optical loss, and high thermal stability with appropriate fluorinated ceramic nanoparticles that possess low refractive index and high thermal conductivity to develop a polymer material for use as a polymer cladding for fiber lasers. The thermal conductivity of a fluorinated polymer is increased by adding ceramic nanoparticles having low refractive indices comparable to the polymer refractive index. This reduces optical scatter and increases the thermal conductivity by orders of magnitude over that of the polymer while maintaining a good compatibility of the polymer and nanoparticles. As shown in FIG. 1, nanoparticles are suspended and evenly distributed in a fluorinated polymer by subjecting the solution to various means of vigorous agitation and/or stirring once the nanoparticles are added. The agitation and/or stirring not only aids in distributing the nanoparticles in the polymer solution, but it also breaks apart any large aggregates of the nanoparticles that may have formed. The final polymer materials are called fluorinated polymer composites (FPCs). Depending on the fluorinated polymer used, the FPCs can be cured thermally or by ultraviolet (UV) irradiation. The FPCs can be fabricated as thin films or as bulk films. The overall final result is FPCs that show low refractive index, low optical losses, high and increased thermal stability, and non-trivial increase in thermal conductivity.

Curing is typically done after the nanoparticles are incorporated into the polymer resins. The term polymer resin suggests that the polymer is in liquid form prior to curing. Polymers can be liquids. For the purpose of this application, the terms “polymer,” “resin,” and “polymer resin” can be used interchangeably in this sense.

Developing a polymer cladding for fiber lasers, including eye-safer fiber lasers is challenging because most polymers do not meet the desirable standards. Furthermore, the addition of ceramic nanoparticles has never been pursued as a solution to this problem. Consequently, this result is unique and non-obvious.

The process of the present invention was demonstrated using a thermally curable resin and a UV curable resin. Either lithium fluoride (LiF) or magnesium fluoride (MgF₂) nanoparticles were added to the resins via vigorous agitation. In one specific example, fluorinated polymers were obtained from DIC (UV cure resin) and from Tetramer (thermal cure resin), and fluorinated nanoparticles were obtained from Intelligent Materials and American Elements. The nanoparticles were incorporated into either polymer resin via agitation and stirring. The mixtures of fluorinated polymer resins containing nanoparticles were then cured either by UV irradiation or by thermal cure to develop the FPCs. The amount of nanoparticles incorporated into the polymer resins ranged from 0-6 vol %. The length of time during which the incorporation by agitation occurred was dependent upon the percentage of nanoparticles added to the polymer resins.

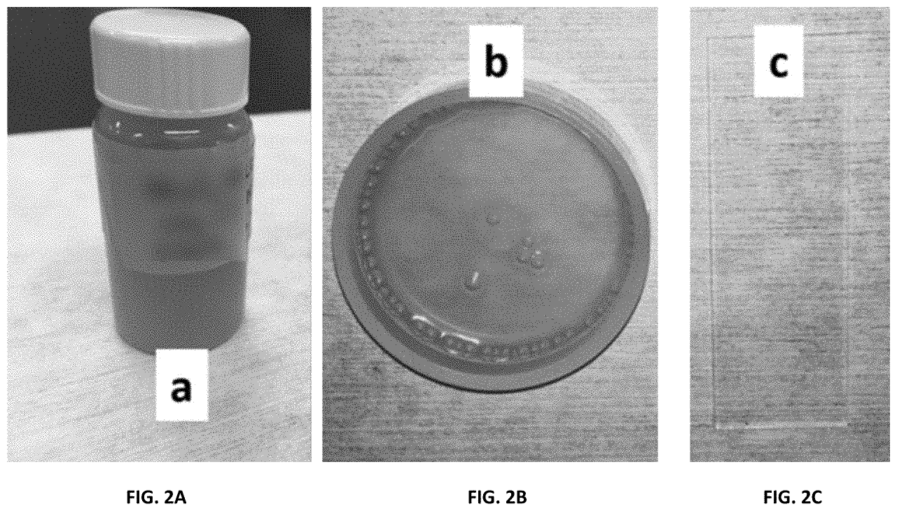

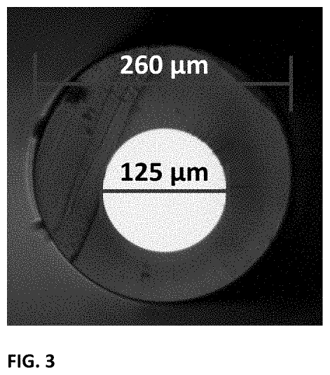

The FPCs can be fabricated as bulk polymers or as thin films (FIGS. 2A, 2B, and 2C). FIG. 2A shows a thermally curable FPC solution prior to curing. FIG. 2B shows a FPC as a bulk polymer, and FIG. 2C shows a FPC as a thin film. The FPCs can also be coated onto fibers at micron-scale thicknesses (FIG. 3). FIG. 3 shows a cross-section image of a silica fiber coated with a FPC.

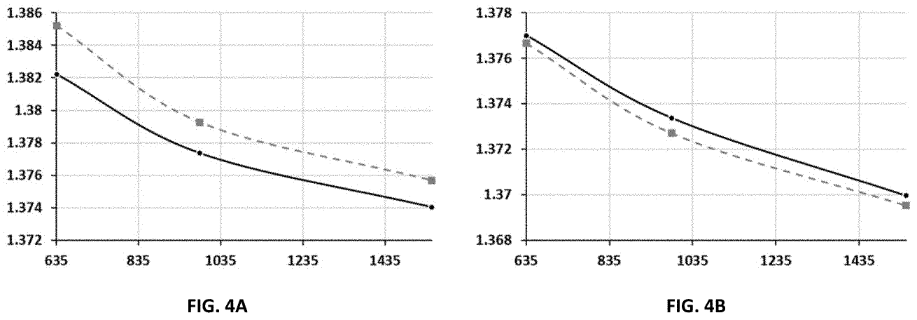

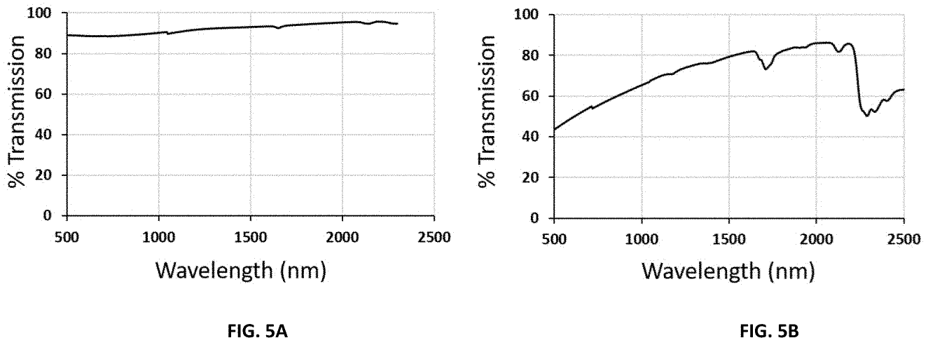

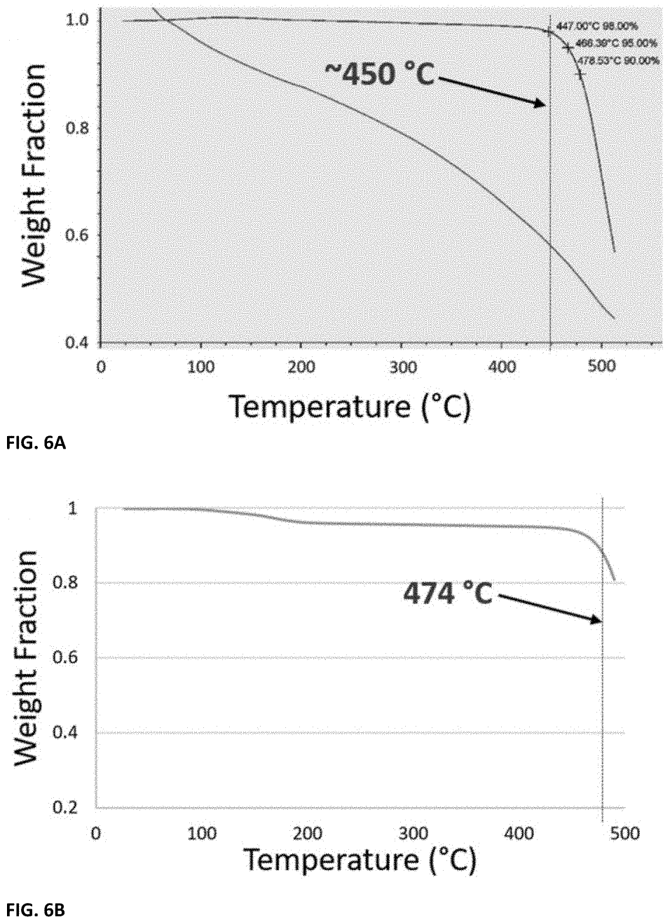

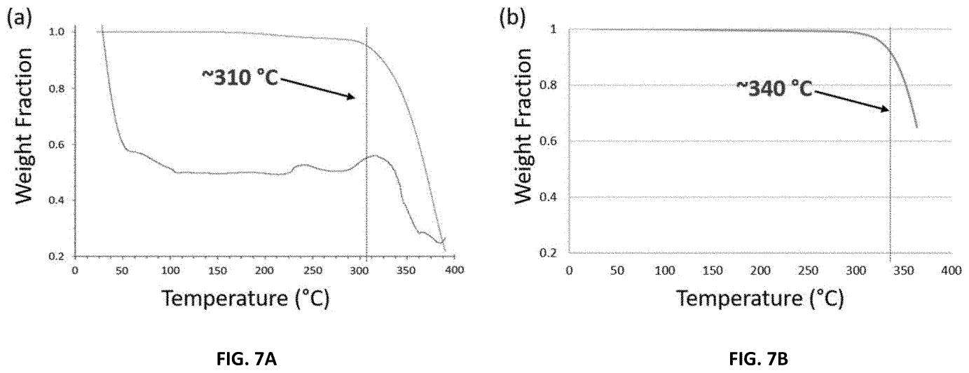

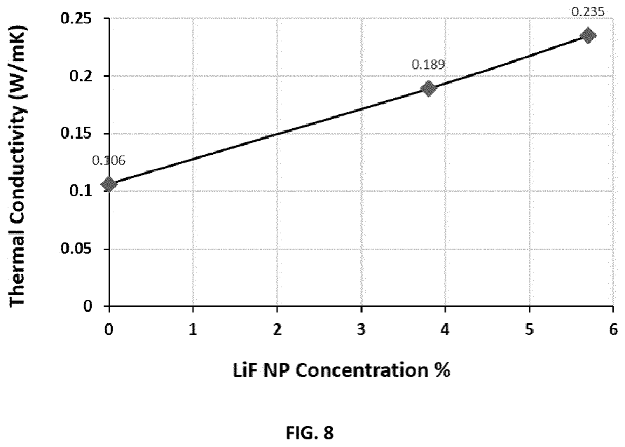

The fluorinated polymer can be thermally curable or ultraviolet (UV) radiation curable. Each polymer has measured refractive indices less than 1.40 before and after the incorporation of ceramic nanoparticles (FIGS. 4A and 4B). FIGS. 4A and 4B show refractive index values at various wavelengths. FIG. 4A is for thermally cured polymers, and FIG. 4B is for UV cured polymers. Additionally, the fluorinated polymer has high transmission after the incorporation of ceramic nanoparticles (FIGS. 5A and 5B). FIG. 5A is a transmission plot for a 200 μm thick thermally cured FPC, and FIG. 5B is a transmission plot for a 6 mm thick UV cured FPC. The fluorinated polymer has improved high thermal stability after the incorporation of ceramic nanoparticles (FIGS. 6A, 6B, 7A, and 7B). FIG. 6A shows a degradation profile as temperature increases for a neat thermally curable polymer, and FIG. 6B shows a degradation profile as temperature increases for a thermally curable FPC. FIG. 7A shows a degradation profile as temperature increases for a neat UV curable polymer, and FIG. 7B shows a degradation profile as temperature increases for a UV curable FPC. Finally, each FPC showed a notable increase in thermal conductivity upon increasing nanoparticle loading (FIG. 8; Tables 1 and 2). FIG. 8 shows a plot of thermal conductivity versus the percentage of LiF nanoparticle concentration for a UV curable FPC.

Since the FPC comprises fluoro-polymer and fluorine based nano-sized particles of similar refractive indices, adverse effects often seen in common optical composite materials (e.g. light scattering and phase segregation) are minimized (FIG. 2B and 2C). Taken together, the addition of ceramic nanoparticles to fluorinated polymers produces fluorinated polymer composites that have low refractive index, low optical loss, high thermal stability and increased thermal conductivity.

TABLE 1
Thermal conductivity data for UV curable FPC polymers
with LiF and MgF₂ nanoparticles in comparison to
a neat UV curable polymer devoid of nanoparticles.

| UV Cure | Nanoparticle | Nanoparticle | Thermal |
|---|---|---|---|
| FPC | diameter (nm) | vol % | conductivity (W/mK) |
| Neat Polymer | N/A | 0 | 0.052 |
| With MgF₂ | ~500 | 3.2 | 0.105 |
| Nanoparticles | | | |
| With LiF | 80 | 3.8 | 0.151 |
| Nanoparticles | | | |

TABLE 2
Thermal conductivity data for thermally curable FPC polymers
with LiF and MgF₂ nanoparticles in comparison to a neat
thermally curable polymer devoid of nanoparticles.

| Thermal Cure | Nanoparticle | Nanoparticle | Thermal |
|---|---|---|---|
| FPC | diameter (nm) | vol % | conductivity (W/mK) |
| Neat Polymer | N/A | 0 | 0.096 |
| With MgF₂ | ~500 | 3.2 | 0.12 |
| Nanoparticles | | | |
| With LiF | 80 | 3.8 | 0.146 |
| Nanoparticles | | | |

Overall, this process is straightforward, scalable, and applicable in numerous markets such as, but not limited to, the optical coatings, laser and sensing markets.

Instead of nanoparticles (<1 μm), microparticles (1-1000 μm) can also be used.

Instead of LiF or MgF₂, other ceramic nanoparticles having matched refractive index to the polymer and high thermal conductivity can be used, including but not limited to, calcium fluoride (CaF₂).

Instead of using the FPCs as polymer claddings for lasers at eye-safer wavelengths, the FPCs can be used as polymer claddings for lasers at lower wavelengths including, but not limited to, 1.0 μm.

The invention is capable of modification, alteration, and equivalents in form and function, as will occur to those ordinarily skilled in the pertinent arts having the benefit of this disclosure. While the present invention has been described with respect to what are presently considered the preferred embodiments, the invention is not so limited. To the contrary, the invention is intended to cover various modifications and equivalent arrangements included within the spirit and scope of the description provided above.

What is claimed:

1. A method for making a fluorinated polymer composite for use as a fiber laser cladding, comprising:
adding ceramic nanoparticles to a fluorinated polymer to form a mixture; and
agitating, stirring, or agitating and stirring the mixture to form a fluorinated polymer composite for use as a fiber laser cladding, wherein the fluorinated polymer composite has a higher thermal conductivity than the thermal conductivity of the fluorinated polymer.

2. The method of claim 1, wherein the ceramic nanoparticles comprise lithium fluoride, magnesium fluoride, or a combination thereof.

3. The method of claim 1, wherein the fluorinated polymer is thermally curable.

4. The method of claim 1, wherein the fluorinated polymer is curable by ultraviolet irradiation.

5. The method of claim 1, wherein the fluorinated polymer and the fluorinated polymer composite each have a refractive index less than 1.4.

6. A fluorinated polymer composite for use as a fiber laser cladding made by the method, comprising:
adding ceramic nanoparticles to a fluorinated polymer to form a mixture; and
agitating, stirring, or agitating and stirring the mixture to form a fluorinated polymer composite for use as a fiber laser cladding, wherein the fluorinated polymer composite has a higher thermal conductivity than the thermal conductivity of the fluorinated polymer.

7. The fluorinated polymer composite of claim 6, wherein the ceramic nanoparticles comprise lithium fluoride, magnesium fluoride, or a combination thereof.

8. The fluorinated polymer composite of claim 6, wherein the fluorinated polymer is thermally curable.

9. The fluorinated polymer composite of claim 6, wherein the fluorinated polymer is curable by ultraviolet irradiation.

10. The fluorinated polymer composite of claim 6, wherein the fluorinated polymer and the fluorinated polymer composite each have a refractive index less than 1.4.

11. A method for making a fiber laser cladding, comprising:
adding ceramic nanoparticles to a fluorinated polymer to form a mixture;
agitating, stirring, or agitating and stirring the mixture to form a fluorinated polymer composite, wherein the fluorinated polymer composite has a higher thermal conductivity than the thermal conductivity of the fluorinated polymer; and
coating the fluorinated polymer composite onto a fiber to form a fiber laser cladding.

12. The method of claim 11, wherein the ceramic nanoparticles comprise lithium fluoride, magnesium fluoride, or a combination thereof.

13. The method of claim 11, wherein the fluorinated polymer is thermally curable.

14. The method of claim 11, wherein the fluorinated polymer is curable by ultraviolet irradiation.

15. The method of claim 11, wherein the fluorinated polymer and the fluorinated polymer composite each have a refractive index less than 1.4.

16. The method of claim 11, wherein the fiber laser cladding has a micron scale thickness.

17. The method of claim 11, wherein the fiber laser cladding surrounds a laser operating at a wavelength greater than 1.4 μm.
